(19) United States
(12) Patent Application Publication
(10) Pub. No.: US 2008/0171509 A1
(43) Pub. Date: Jul. 17, 2008

(54) Device For Ventilating Vehicles

(75) Inventors: Sebastian Grossmann, Moglingen (DE); Dietrich Klingler, Heubach (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/996,709

(22) PCT Filed: Jul. 25, 2006
(86) PCT No.: PCT/EP2006/007303

§ 371 Date: Mar. 21, 2008

(30) Foreign Application Priority Data
Jul. 25, 2005 (DE) 10 2005 035 248.0

(51) Int. Cl. B60H 1/34; B60H 1/24

(52) U.S. Cl. 454/155

(57) ABSTRACT

A device for ventilating vehicles, with at least one nozzle (3), the discharging direction of which can be adjusted, and with an actuating device (20), which is at least partially arranged outside the nozzle (3), in order to adjust the discharging direction of the nozzle. In this case, the actuating device (20) has a first actuating element which is rotatable about a first geometrical axis and a second actuating element which is rotatable with respect to a second geometrical axis (Y), for adjusting the discharging direction. Furthermore, an operating device (26) is provided for operating the two actuating elements (23, 24), the operating device being connected to the actuating elements (23, 24) in such a manner that operation of the operating device in a first operating direction moves the first actuating element and operation of the operating device in a second operating direction moves the second actuating element.

The present invention relates to a device for ventilating vehicles. Such devices are known from the prior art and are used for example in passenger vehicles or trucks for ventilating the passenger compartment. The present invention is described with reference to a passenger vehicle, though it is pointed out that the invention can also be used in other vehicles such as trucks, boots, motorcycles, rail vehicles, aircraft or the like.

In the prior art, such devices for ventilating vehicles have a nozzle through which air enters into the interior space of the vehicle. Here, it is known to design the nozzles such that the outflow direction of the air which passes through said nozzles is variable. This can be obtained for example by means of pivotable lamellae or also by means of ducts which are arranged within the nozzle and which are pivotable with respect to the nozzle. DE 103 39 339 A1, which is included by way of reference in the present description, discloses a nozzle for a motor vehicle which has two flow ducts, one of which is adjustable in terms of its outflow direction.

In the prior art, in order to adjust the above-mentioned lamellae or ducts, actuating units are provided. Here, it is necessary in the prior art to provide separate actuating units for the horizontal and the vertical adjustment of the emerging air. For precise positioning of the outflow direction, it is therefore necessary for in each case two actuating units to be actuated. Said actuating units are usually knurled wheels which are arranged below and to the side of the air outlet opening of the nozzle respectively.

Also known are devices in which the actuating units are arranged on a grille of the nozzle, that is to say within the nozzle.

The object on which the present invention is based is that of providing a device for ventilating vehicles which makes it possible to define the adjustment of the outflow direction both in the horizontal and also in the vertical direction with only one actuating device. The operation of the nozzle should thereby be simplified.

This is achieved according to the invention by means of a device as claimed in claim 1 and by means of an actuating device as claimed in claim 19. Advantageous embodiments and refinements are the subject matter of the subclaims.

The device according to the invention for ventilating vehicles has at least one nozzle whose outflow direction is adjustable. In addition, at least one actuating device, which is arranged at least partially outside the nozzle, is provided for adjusting the outflow direction of the nozzle. The actuating device has a first actuating element, which is rotatable about a first geometric axis, and a second actuating element, which is rotatable with respect to a second geometric axis, for adjusting the outflow direction. The actuating device also has an operating device for operating the two actuating elements. According to the invention, the operating device is connected to the actuating elements in such a way that, by operating the control device in a first operating direction, the first actuating element is moved, and by operating the control device in a second operating direction, the second actuating element is moved.

The outflow direction is to be understood to mean the direction in which a predefined proportion of the air emerging from the nozzle emerges with respect to the nozzle, or the corresponding main flow direction of the emerging air.

An element which is arranged at least partially outside the nozzle is to be understood to mean that the element in question is arranged in particular in the peripheral direction outside the nozzle or outside a housing of the nozzle. The actuating device is preferably arranged to the side of or above or below the nozzle.

The first actuating element is rotatable with respect to a first geometric axis by at least a predefined angle such as for example an angle of 30 degrees. The second actuating element is movable about a second axis, wherein in this case, the second actuating element can be arranged so as to be both rotatable about the second axis and also movable for example in the longitudinal direction of the second axis. Combinations of said movement directions are also conceivable.

The two actuating elements serve to adjust the outflow direction of the nozzle. An operating device is to be understood to mean a device which can be operated in particular by the driver or user of the passenger vehicle and by means of which the driver can control the outflow direction of the nozzle.

An operation of the operating device is to be understood to mean any type of actuation such as in particular, but not exclusively, a rotation, movement, pressing action or also combinations of said actuations. Here, the first operating direction is an operation direction which is different than the second operating direction. Examples for different operating directions are a rotation of a sphere about different axes, a movement of an actuating element in directions which are not parallel to one another, a pressing action on the one hand and a rotation or sliding of an actuating element on the other hand, and the like.

An operation of the operating device in the first operating direction preferably brings about a movement only of the first actuating element, whereas an operation of the operating device only in the second operating direction brings about a movement only of the second actuating element. A movement of the operating device which has both a component in the first operating direction and also a component in the second operating direction consequently brings about a movement of both actuating elements.

The first actuating element is preferably coupled to the nozzle by means of a first movement transmission device and the second actuating element is preferably coupled to the nozzle by means of a second movement transmission device. Here, the movement transmission devices can for example be coupled to lamellae which are provided at the outlet opening of the nozzle, or can also be moved with a duct, which is situated within the nozzle, of said nozzle. In a further preferred embodiment, it is however also possible for only one of the actuating elements to be coupled to a movement transmission device.

A movement transmission device is to be understood to mean any device which is suitable for converting a movement of one body into a movement of another body. In the narrower sense, said movement transmission devices are mechanical devices which convert the movement directly. In the wider sense, said movement transmission devices can however also be motors, magnets or the like which are activated by the movement of a body and set another body in motion.

In a further preferred embodiment, a shortest spacing of the geometric axes around which the actuating elements are arranged so as to be rotatable or movable extends from a first point between the end points of the first axis to a second point between the end points of the second axis. This means that the two geometric axes can for example lie in the same plane or, in the projection from a direction which is perpendicular to the plane spanned by the two axes, can intersect. The two axes could also coincide parallel to one another. This would be possible for example if the actuating element is rotated about an axis and is moved with respect to the same axis or with respect to an axis parallel to said axis.

The second actuating element is however arranged so as to be rotatable about the second axis, with the first axis and the second axis being arranged substantially perpendicular to one another. In a further preferred embodiment, the first axis and the second axis have a common point of intersection, that is to say they are arranged in a common plane. By means of said design, it is possible to obtain that, by means of the two actuating elements, all the points situated on a hemisphere or a predefined spherical segment can be reached in a uniform fashion.

In a further preferred embodiment, the nozzle has a first flow duct which is pivotable about a first rotational axis. Said flow duct preferably has a circular or elliptical cross section, though other cross sections such as polygonal cross sections and the like are also conceivable. The first flow duct is preferably also pivotable about a second rotational axis, with the second rotational axis and the first rotational axis particularly preferably being substantially perpendicular to one another. This means that the first flow duct can be pivoted in two perpendicular directions, such as for example vertically and horizontally. In this way, the outflow direction of the air emerging from the nozzle can be varied both in the vertical and also in the horizontal direction. The first flow duct is preferably constructed from at least two sections which are pivotable relative to one another, with the axes about which the sections can be pivoted particularly preferably being perpendicular to one another.

In a further preferred embodiment, the nozzle has a second particularly preferably non-movable flow duct, with the first flow duct preferably being arranged substantially within the second flow duct. This means that the air can pass both through the first, inner flow duct and also through the area which is situated between the peripheral edge of the first flow duct and the peripheral edge of the outer second flow duct. More precisely, the second flow duct is formed by said area.

The air flow in the first, or inner, flow duct is preferably directed, while the air flow in the outer, or second, flow duct is provided with a swirl, with the outer air flow being guided in particular in a helical manner around the inner flow duct. On account of the swirl action, a diffuse air flow is generated at the outlet.

The nozzle can also be of multi-part, in particular two-part design, with the two nozzle parts being designed so as to correspond to one another, having in each case a first and a second flow duct, and the in each case first flow duct being movable. It is also possible for a plurality of substantially identical nozzles to be provided. In a further preferred embodiment, the nozzle has pivotable lamellae. Said lamellae are preferably arranged at the outlet of the nozzle, as stated above.

At least one movement transmission device is preferably connected to the first flow duct. This means that the first flow duct can be moved in at least one direction by the actuating device, and can in particular be pivoted about an axis.

The second movement transmission device is preferably also connected to the first flow duct. In this way, it is obtained that the flow duct can be moved about both axes with the actuating device. It is however also possible to connect a movement transmission device to lamellae, and in this way to vary the air outlet direction by means of a combination of a movement of the first flow duct and of the lamellae.

In a further preferred embodiment, the actuating device has a frame to which at least one actuating element is articulatedly connected. The frame preferably has a substantially circular cross section, and the actuating elements are arranged in each case at an angular interval of 90 degrees with respect to one another.

In a further preferred embodiment, at least one movement transmission device is connected in a particular way to at least one actuating element. The two movement transmission devices are preferably connected, particularly preferably by means of a joint connection, to the two actuating elements, so that a movement of the actuating elements can be transmitted into a movement of the flow duct or of the lamellae in the nozzle.

In a further preferred embodiment, the actuating elements have guide elements, in particular but not exclusively in the form of slots, which are arranged substantially perpendicular to one another. Further movement elements can be moved in said guide elements. The operating device preferably has a projection or is connected to a projection which runs at least partially in the guide elements. Said projection can for example be a pin or the like which runs in guide rails or guide gaps of the two actuating devices. This is explained in more detail with reference to the figures.

In a further preferred embodiment, the operating device has a substantially spherical design.

Alternatively, a control lever can also be provided which can be moved in two different or arbitrary directions.

The present invention is also aimed at an actuating device, in particular for a device as specified above, which actuating device has a first actuating element, which is rotatable about a first geometric axis, and a second actuating element, which is rotatable with respect to a second geometric axis, and an operating device for operating the two actuating elements. Here, according to the invention, the operating device is connected to the actuating elements in such a way that, by operating the control device in a first operating direction, the first actuating element is moved, and by operating the control device in a second operating direction, the second actuating element is moved.

The first movement transmission device and the second movement transmission device are preferably rods which are particularly preferably connected by means of joints to the actuating element and elements of the nozzle. It is however also conceivable to provide gearwheels, driving rubber wheels and the like which transmit the movement. A transmission of the movement could also take place by means of belts, chains or the like. In addition, motors could be used as movement transmission devices, which motors are controlled by means of the actuating elements and transmit a movement, which is controlled in this way, to elements of the nozzle.

The invention is also aimed at a ventilation system for a vehicle having a device of the above-described type. The ventilation system preferably has a plurality of such devices, that is to say nozzles with associated controllers. It is also possible to control two nozzles simultaneously by means of one actuating device.

The invention is also aimed at a motor vehicle having a ventilation system of the above-described type.

Further advantages and embodiments can be gathered from the appended drawings, in which:

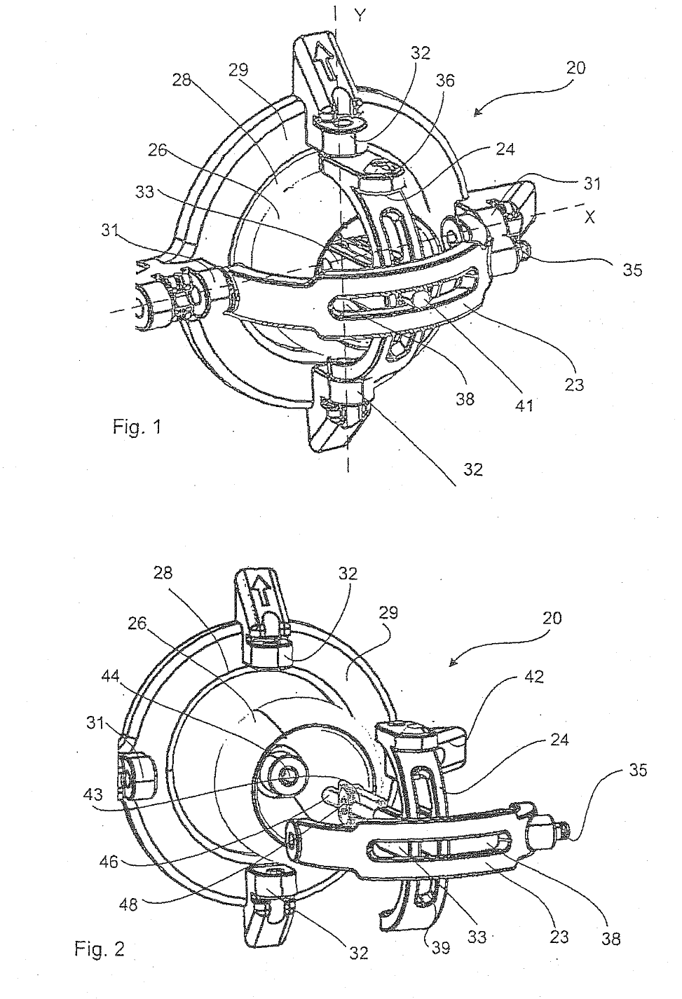

FIG. 1 shows an actuating device according to the invention;

FIG. 2 shows the actuating device from FIG. 1 in an exploded illustration;

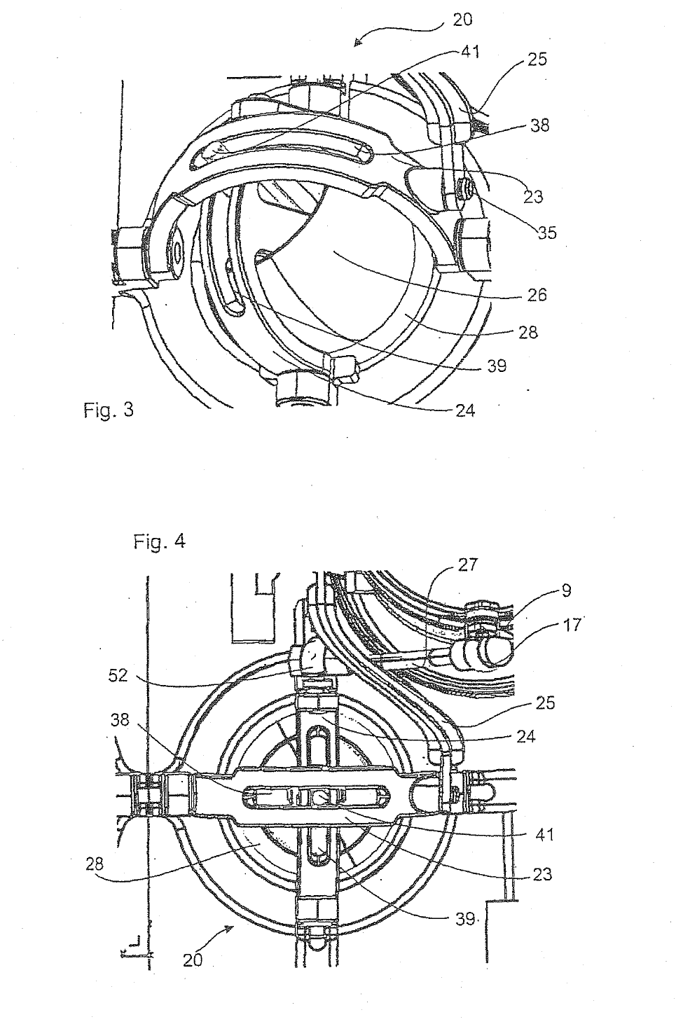

FIG. 3 shows a detailed illustration of the actuating device from FIG. 1 in a further illustration;

FIG. 4 shows a plan view of the actuating device from FIG. 1;

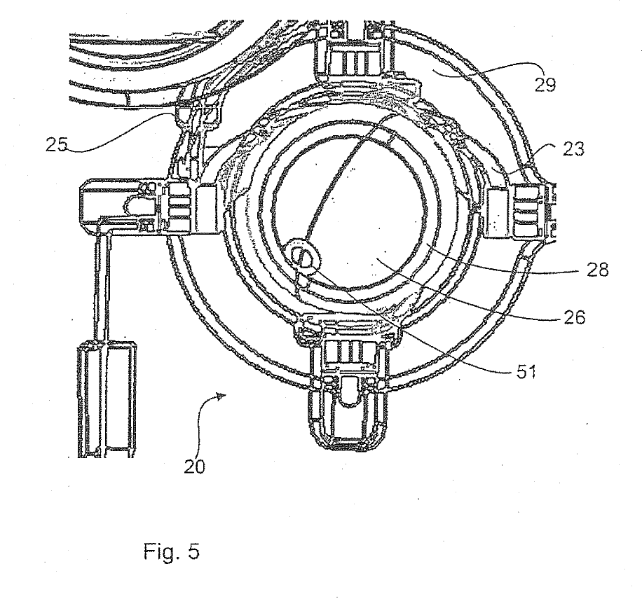

FIG. 5 shows a front view of the actuating device according to the invention;

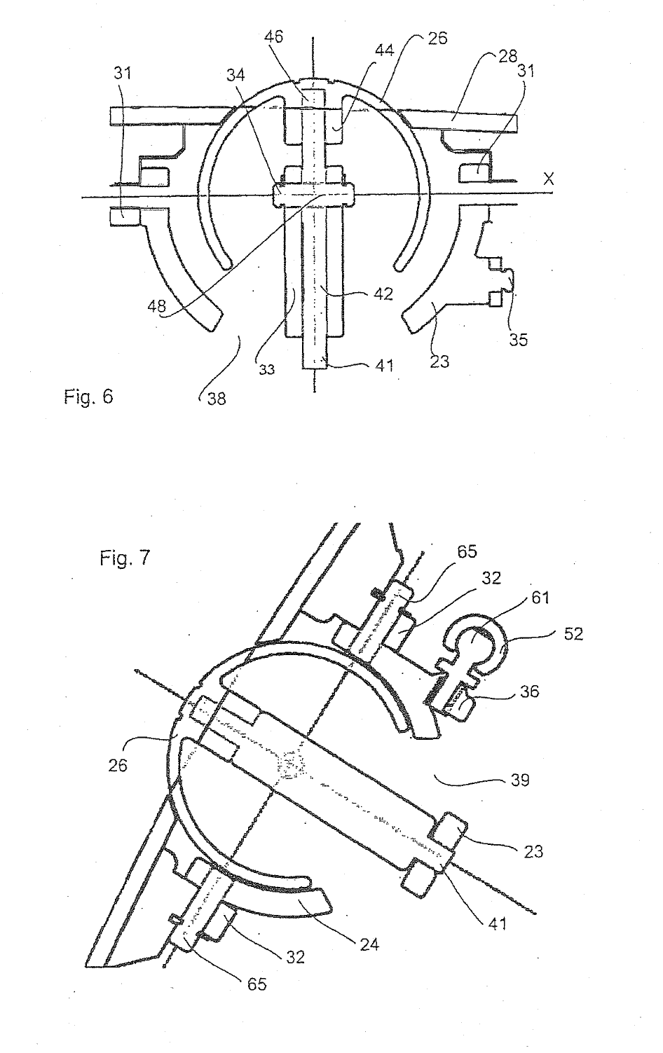

FIG. 6 shows a section illustration of the actuating device from FIG. 1;

FIG. 7 shows a further section illustration of the actuating device from FIG. 1;

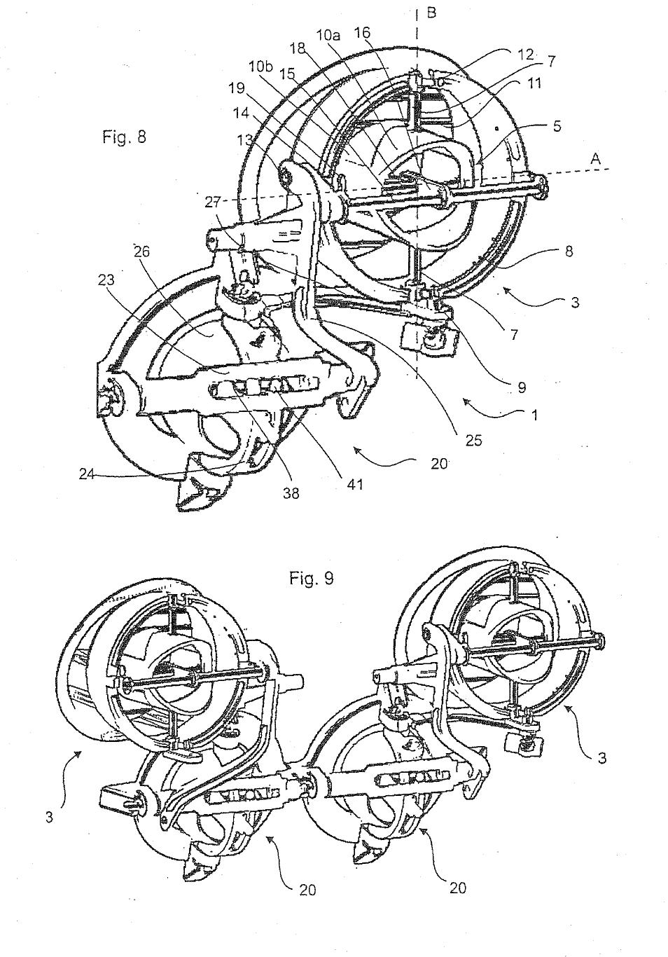

FIG. 8 shows an illustration of a device according to the invention for ventilating vehicles; and

FIG. 9 shows an illustration of a ventilation system with two nozzles.

FIG. 1 shows an actuating device according to the invention in a perspective illustration. Said actuating device has a first actuating element 23 which is mounted so as to be rotatable or pivotable about an axis X (shown in dashed lines). A second actuating element 24 is mounted so as to be rotatable or pivotable about an axis Y (shown in dashed lines). The two actuating elements 23, 24 can be moved independently of one another by means of a driver pin 41. Said driver pin 41, as is shown in detail below, is likewise arranged so as to be rotatable about the axes X and Y and is fixedly connected to an operating device 26. Said operating device 26 can be operated by the user from the vehicle interior space.

If the operating device 26 is rotated downward in FIG. 1, this results in the actuating element 23 moving upward. The operating device 26 is in this embodiment embodied as a calotte shell which is held by a ring 28 of the actuating device 20.

In the event of a horizontal movement of the operating device 26 to the right, the driver pin 41 moves to the left.

The reference sign 36 relates to a joint device 36 for articulatedly connecting a movement transmission device (not shown in FIG. 1). The brackets 31, 32 serve to mount the actuating elements 23, 24.

FIG. 2 shows an exploded view of the actuating device shown in FIG. 1. It can be seen that the operating device 26 has, in the center, a socket 44 for receiving a pin 46. A holding element 43 forms the connection between the operating device 26 and the driver pin 41 (not shown in FIG. 2).

The actuating element 23 is articulatedly connected to the brackets 31, 32 by means of pins (not shown). The articulation of the upper and lower ends of the actuating element 24 in the holding elements 32 also takes place in the same way.

The reference sign 33 relates to a holding device which is fixedly connected to or integrally formed with the actuating element 23 and which projects inward. The holding device 33 serves to rotatably mount the operating device 26, as explained below. The brackets 31, 32 are fixedly arranged on a frame 29.

FIG. 3 shows a further perspective illustration of the actuating device 20 according to the invention. The reference symbol 25 relates to a first movement transmission device which is articulatedly connected, so as to be rotatable, to the actuating element 23 by means of a bearing 35. The movement transmission device itself is preferably of rigid design and moves upward and downward with the actuating element 23.

In a similar way, a movement transmission device (not shown in FIG. 3) is also provided on the actuating element 24.

FIG. 4 shows a plan view of the actuating device 20 according to the invention. In the illustration shown in FIG. 4, the driver pin 41 is in its central position. The driver pin 41 can be moved in a horizontal direction in a horizontal slot 38 which is arranged in the actuating element 23. A movement of the driver pin in a vertical slot 39 of the second actuating element 24 is also correspondingly possible. The actuating element 24 is also, as shown above, connected by means of a bearing 52 to the second movement transmission device 27 in order to transmit horizontal movements. The second movement transmission device 27 is coupled by means of a joint element 17 and a bearing 9 to the flow duct 5 (not shown). By means of suitable shaping of the first movement transmission device 25 and of the second movement transmission device 27, it is obtained that said movement transmission devices do not impede one another, regardless of the respective position of the two actuating elements 23 and 24. The movement transmission device 25 therefore serves for the vertical adjustment of the flow direction of the air emerging from the nozzle, and the movement transmission device 27 serves for the horizontal adjustment of the emerging air.

FIG. 5 shows a front view of the actuating device 20, that is to say a view as seen by the driver in the vehicle interior space. For illustrative purposes, however, the hidden elements such as the actuating device 23, which is situated behind the dashboard, are also shown. The operating device 26 which, as mentioned above, has a spherical design, is held by a ring 28. A marking 51 is attached to the operating device 26, which marking 51 indicates to the user the position of the operating device 26. If the marking 51 is situated in the centre of the ring 51, this means that the flow direction of the nozzle is aligned straight, or the actuating elements 23, 24 are situated in a central position.

The operating device, which is embodied here as a calotte shell, can also be produced from a transparent material, thereby permitting illumination of the operating device 26. The operating device 26 can also be produced from luminescent material. A lever can also be provided instead of a calotte shell.

By rotating the operating device 26, the driver can act on the actuating elements 23 and 24 and therefore on the flow direction of the air emerging from the first nozzle.

FIG. 6 shows a section in the plane which is spanned. in FIG. 1 by the X axis and the Z axis and which is perpendicular to the plane spanned by the X axis and the Y axis.

It can be seen that, as stated above, the operating device 26 has a socket 44 into which a pin 46 engages in order to thereby ensure a fixed connection between the operating device 26 and the driver pin 41.

The driver pin 41 and the pin 46 are preferably integrally arranged as the upper and lower ends on a rotary body 42.

The rotary body 42 has, as mentioned above, an opening 48 through which a pin 34 projects. The operating device 26 can be rotated by means of the pin 34 relative to the holding device 33 which is fixedly connected to the actuating element 24, thereby allowing the operating device to be rotated by the user. The reference symbol 28 relates again to the ring which serves to hold the operating device 26. The slot, within which the driver pin 41 can move, of the actuating element 23 is arranged in the region denoted by 38.

The reference symbol 35 relates to a bearing device to which, as mentioned above, the movement transmission device 25 is articulatedly connected.

FIG. 7 shows a section in the plane spanned by the Y and Z axes. It can be seen that the actuating element 24 is mounted so as to be rotatable relative to the brackets 32 by means of a pin 65. The reference symbol 39 relates to a vertical slot of the second actuating element 24. Said slot serves at the same time to determine the angle by which the operating element can be rotated in the vertical direction. The reference symbol 36 relates to a joint device which is arranged on the actuating element 24 and in which a connecting pin 61 is rotatably mounted. At the opposite end, the pin 61 has a head which in turn engages in a joint device 52. Said joint device 52 is a constituent part of the movement transmission device 27 (not shown in FIG. 7).

FIG. 8 shows an overall illustration of an actuating device 20 and a nozzle 3 which is actuated by the latter. If the operating device 26 is actuated in the horizontal direction, the actuating element 23 is not actuated by the driver pin 41, since the latter can move substantially freely within the slot 38 in the horizontal direction. The driver pin 41, however, actuates the second actuating element 24 and rotates it about the Y axis shown in FIG. 1. As a result of said rotation, the movement transmission device 27, which is used for the horizontal adjustment of the nozzle, is also moved.

That end of the movement transmission device 27 which faces toward the nozzle 3 is arranged by means of a bearing device (not shown in detail) on a rotary plate 9 which brings about a rotational movement of a shaft 7. The shaft 7 is fixedly connected to the first flow duct 5 which, in this embodiment, is formed as a cylinder. This means that, in this embodiment, only the first flow duct 5 can move, whereas the second flow duct 8 remains substantially rigid. The rotation of the flow duct 5 then takes place about the axis B (shown in dashed lines). The upper and lower part of the shaft 7 is articulatedly connected, so as to be rotatable, to the housing 6 of the nozzle by means of joint connections.

In the event of a vertical movement of the operating device 26, the actuating element 24 is not actuated, but rather the driver pin 41 brings about an actuation only of the first actuating element 23, since the driver pin can move within the vertical slot of the actuating element 24. The movement of the actuating element is transmitted by means of the movement transmission device 25 to a lever 14 which is mounted by means of a pin 13 so as to be rotatable relative to the second movement transmission device 25. The force exerted by the actuating element 23 is therefore transmitted via the shaft 15 to the first flow duct 5 and has the effect that said first flow duct 5 likewise moves in the vertical direction in the event of an actuation of the operating device 26.

In detail, in the event of a movement of the operating device 26 in the downward direction, the actuating element 23 is moved upward. As a result of said movement, the movement transmission device 25 is also moved upward, and in turn brings about a clockwise rotation of the shaft 15 by means of the pin 13 and the lever 14. As a result of said clockwise rotation of the shaft 15, a forked arm 16 which is rotationally fixedly arranged on the shaft is also moved clockwise.

The first flow duct 5 is of articulated design and has two adjacent and substantially hollow cylindrical sections 10a and 10b. Said sections 10a and 10b are pivotable about in each case one axis A and B, which axes A and B are arranged transversely with respect to the longitudinal direction of the nozzle, with the axes A and B being aligned perpendicular to one another. While both sections 10a and 10b are pivoted about the above mentioned axis B, only the front section 10b is pivoted here in the vertical direction about the axis A.

As a result of the above mentioned clockwise rotation of the forked arm 16, the rear section 10a is therefore also pivoted upward, so that as a result, the actuation of the operating device in a downward vertical direction also brings about a—downward—pivoting movement of the section 10b of the nozzle. Conversely, an—upward—movement of the operating device brings about an—upward—movement of the section 10b of the flow duct 5.

The forked arm 16 thereby provides a transmission of movement in the vertical direction. The forked arm 16 holds a transverse axle 18, which is provided on the second section 10b, in a pivotable and longitudinally movable manner. In the event of a rotation of the forked arm 16, said transverse axle 18 is driven in each case. The driving action has the effect that the second section 10b is moved relative to the first section 10a about a joint 19 and a further joint (not shown) on the opposite side of the flow duct 5. Said joints are arranged behind the transverse axle 18 in FIG. 8, so that in the event of a clockwise movement of the forked arm 16, the section 10b is pivoted counterclockwise, and therefore also downward, about the joints 19.

It is alternatively possible for an activation of the lamellae 11 to also take place by means of the movement transmission device 25, so that said lamellae 11 are correspondingly inclined. Lamellae which run in the vertical direction, and which can be correspondingly activated by means of the second movement transmission device 27, could also be provided. Combinations of vertical and horizontal lamellae for controlling the flow direction of the emerging air are likewise conceivable.

As mentioned, the control of the movable elements of the nozzle 3, such as for example of the first flow duct 5 or of the lamellae 11, could also be carried out by means of a gearwheel controller, rubber or chain drives, rubber wheels or the like. The actuating elements 23 and/or 24 could also, by means of their movement, activate motors which then carry out the control of the flow duct 5 or of the lamellae.

FIG. 9 shows a ventilation system for a vehicle which has two nozzles 3 and two actuating devices 20. In this case, the control of the two nozzles 3 can take place separately by means of the in each case associated actuating device 3. As shown in FIG. 9, the respective actuating devices 20 and the nozzles 3 are constructed symmetrically with respect to one another. In another embodiment, it would be possible to activate both nozzles by means of one actuating device. Here, the two nozzles could be connected to one another by means of suitable rods or movement transmission devices so that the two nozzles are adjusted synchronously.

The embodiment shown in FIG. 9 is however preferable because, in a motor vehicle, the flow direction of the air can be adjusted by a driver and a co-driver independently of one another. The ventilation system shown in FIG. 9 can for example be used in the central region of a motor vehicle dashboard. Corresponding individual ventilation arrangements can additionally be arranged at the left-hand and right-hand sides of the motor vehicle.

All the features disclosed in the application documents are claimed as being essential to the invention provided that they are novel, individually or in combination, over the prior art.

1. A device for ventilating vehicles, having at least one nozzle whose outflow direction is adjustable, having an actuating device, which is arranged at least partially outside the nozzle, for adjusting the outflow direction of the nozzle, with the actuating device having a first actuating element, which is rotatable about a first geometric axis, and a second actuating element, which is rotatable with respect to a second geometric axis, for adjusting the outflow direction, and an operating device for operating the two actuating elements, wherein the operating device is connected to the actuating elements in such a way that, by operating the control device in a first operating direction, the first actuating element is moved, and by operating the control device in a second operating direction, the second actuating element is moved.

2. The device as claimed in claim 1, wherein the first actuating element is coupled to the nozzle by means of a first movement transmission device and the second actuating element is coupled to the nozzle by means of a second movement transmission device.

3. The device as claimed in claim 1, wherein the shortest spacing of the axes extends from a first point between the end points of the first axis to a second point between the end points of the second axis.

4. The device as claimed in claim 1, wherein the second actuating element is arranged so as to be rotatable about the second axis.

5. The device as claimed in claim 1, wherein the first axis and the second axis are arranged substantially perpendicular to one another.

6. The device as claimed in claim 1, wherein the first axis and the second axis have a common point of intersection.

7. The device as claimed in claim 1, wherein the nozzle has a first flow duct which is pivotable about a first rotational axis.

8. The device as claimed in claim 7, wherein the first flow duct is pivotable about a second rotational axis.

9. The device as claimed in claim 8, wherein the first rotational axis and the second rotational axis are substantially perpendicular to one another.

10. The device as claimed in claim 1, wherein the nozzle has a second, non-movable flow duct.

11. The device as claimed in claim 7, wherein the first flow duct is arranged substantially within the second flow duct.

12. The device as claimed in claim 1, wherein the nozzle has pivotable lamellae.

13. The device as claimed in claim 1, wherein at least one movement transmission device is connected to the first flow duct.

14. The device as claimed in claim 1, wherein the actuating device has a frame to which at least one actuating element is articulatedly connected.

15. The device as claimed in claim 1, wherein at least one movement transmission device is connected to at least one actuating element by means of a joint connection.

16. The device as claimed in claim 1, wherein the actuating elements have guide elements which are arranged substantially perpendicular to one another.

17. The device as claimed in claim 16, wherein the operating device is connected to a projection which runs at least partially in the guide elements.

18. The device as claimed in claim 1, wherein the operating device has a spherical design at least in sections.

19. An actuating device as claimed in claim 1, comprising a first actuating element, which is rotatable about a first geometric axis, and a second actuating element, which is rotatable with respect to a second geometric axis, for adjusting the outflow direction, and an operating device for operating the two actuating elements, wherein the operating device is connected to the actuating elements in such a way that, by operating the control device in a first operating direction, the first actuating element is moved, and by operating the control device in a second operating direction, the second actuating element is moved.

20. A ventilation system comprising a device as claimed in claim 1.
